(19) United States
(12) Patent Application Publication
(10) Pub. No.: US 2015/0331880 A1
(43) Pub. Date: Nov. 19, 2015

(54) STORAGE-PERFORMED DATABASE QUERY

(71) Applicant: Futurewei Technologies, Inc., Plano, TX (US)

(72) Inventor: Zhuang WANG, San Jose, CA (US)

(73) Assignee: Futurewei Technologies, Inc., Plano, TX (US)

(21) Appl. No.: 14/279,157

(22) Filed: May 15, 2014

(51) Int. Cl. G06F 17/30

(52) U.S. Cl. CPC G06F 17/30103; G06F 17/30218; G06F 17/30109

(57) ABSTRACT

System and method include performing a query of a database. A method includes a storage system receiving a database query from a database server. One or more storage devices from the storage system scan one or more database tables for entries that satisfy a first criteria of the database query. The storage devices determine a first results set from the tables and return the first results set to a management node of the storage system. The management node scans the first results set for entries that satisfy a second criteria of the database query. The management node returns a final results set to the database server.

### FIELD OF THE INVENTION

The present disclosure relates generally to the field of database systems, and more specifically, to the field of storage intelligence in database system.

### BACKGROUND OF THE INVENTION

A conventional database system includes a server, such as a database server, and storage for maintaining data of the database system. There are input/output (I/O) connectors for connecting the database server and the storage. Traditionally, database intelligence resides with the database server—when the database server runs database commands to interact with the database, the commands are sent via the I/O to storage, and the storage retrieves the pertinent data and sends it back to database server for processing. In a conventional database system, storage does not possess database intelligence and therefore does not execute any data processing, rather storage simply returns data to the database server for processing there. Conventional storage cannot understand, for example, Structured Query Language (SQL) instructions, and therefore the storage must retrieve and transfer the complete table(s) referenced by the database query to the database server. The database server performs the instructions according to the query in order to filter the data and find the appropriate result.

This may cause inefficiency in the data transport over I/O, as the total table size must be transferred to the database server in order to process the query, when perhaps the query result has a much smaller size than that of the total table. Such data transport inefficiency may lead to a strain on the I/O between database server and the storage, and may slow down query processes due to transfers of a large amount of unnecessary data.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, embodiments according to the present disclosure include a system and method for performing a query of a database. A method includes a storage system receiving a database query from a database server. One or more storage devices from the storage system scan one or more database tables for entries that satisfy a first criteria of the database query. The storage devices determine a first results set from the tables, and return the first results set to a management node of the storage system. The management node scans the first results set for entries that satisfy a second criteria of the database query. The management node returns a final results set to the database server.

More specifically, an aspect of the present disclosure provides a system for performing a query of a database. The system includes a database computing device, and a storage device including a processor and one or more storage units. The storage device includes a database and is able to communicate with the database computing device. The database includes one or more tables stored by one or more of the storage units. The storage device is configured, in response to a database query, to cause the storage units to scan tables for entries that satisfy a first criteria of the database query and to determine a first results set. The storage device is configured to scan the first results set for entries having values that satisfy a second criteria of the database query, and to return to the database computing device a final results set including entries having values satisfying all criteria of the database query.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a schematic diagram depicting an exemplary database system in accordance with an embodiment of the present disclosure.

FIG. 2 depicts an exemplary storage database join process in accordance with an embodiment of the present disclosure.

FIG. 3 depicts an exemplary database system in accordance with an embodiment of the present disclosure.

FIG. 4 is a flowchart illustrating an exemplary process in accordance with an embodiment of the present disclosure.

FIG. 5 is a block diagram illustrating an exemplary computer system, with which embodiments of the present disclosure may be implemented.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Embodiments of the present disclosure pertain to systems and methods for performing database queries by a storage system in a database system, via implementation of database intelligence at the database storage system. In one aspect of the present disclosure, database intelligence is implemented on the storage system via a management node, where the management node includes computing capability, and the management node is able to communicate with each storage device in the storage system and also with a database server in the database system. In one aspect, the management node enables minimized data transfer between a database server and a storage system by performing a database table join for a database query at the storage system, and transferring only the final results of a database query to the database server. Herein, a “management node” may refer to a general-purpose processor, such as a central processing unit (CPU), executing stored program instructions according to embodiments of the present disclosure. Alternatively or additionally, the management node may refer to a special-purpose computing device persistently programmed to perform the techniques described in the present disclosure.

### Storage System for Performing Database Queries

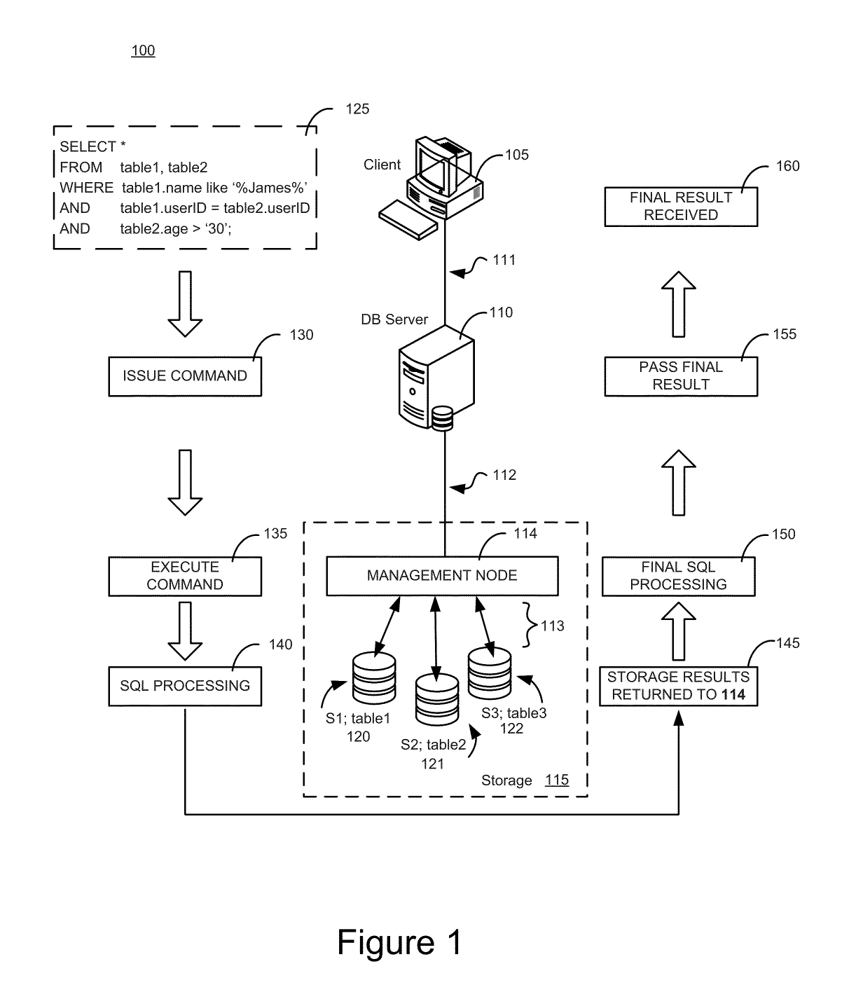

FIG. 1 depicts an exemplary database system 100 in accordance with an embodiment of the present disclosure. Database system 100 includes a client computing device 105 in communication with a database management device 110. In an embodiment the database management device 110 is a database server, which governs and facilitates access to a particular database, processing requests by clients to access the database. The database system 100 includes a storage system 115 in communication with database management device 110. The storage system 115 includes storage devices 120, 121, and 122, each of which includes a database table or tables. Storage devices 120-122 may include non-transitory memory, and may comprise any suitable type of storage device such as one or more of random access memory (RAM), hard disk drive, Flash storage, etc. Additionally, the storage devices 120-122 may include computing capability, such as a general-purpose CPU or special-purpose computing device. The computing capability of the storage devices enables each storage device to perform some database queries locally, at the storage device. The storage devices 120-122 may comprise a single type of storage device or a collection of storage devices of a different type. While only three storage devices including database tables are shown in FIG. 1, a greater or lesser number of storage devices including a greater or lesser number of database tables is possible, and is consistent with the spirit and scope of the present disclosure. The storage system 115 further includes a management node 114, the management node 114 in communication with each storage device of the storage system 115 and with the database computing device 110.

Communication between the components of the database system 100 is accomplished by data transfer across input/output (I/O) connectors in the system. I/O 111 connects the client computing device 105 with the database management device 110. I/O 112 connects the database management device 110 to the storage system 115, and I/O 113 connects the management node 114 with storage devices 120-122. I/O connectors may be for example, Ethernet, InfiniBand, and/or other I/O architectures and protocols known to one skilled in the art.

Exemplary steps for database system 100 to process a query from client device 105 are illustrated via FIG. 1 elements 125-160. A database query 125 is generated at the client device 105. In the example query SQL syntax is shown, however embodiments of the present disclosure are not limited to a particular database language. The query 125 is a SELECT all statement from a table1 and a table2 (comprised by storage device 120 and storage device 121, respectively), WHERE table1.name LIKE ‘% James %’ AND table1.userID=table2.userID AND table2.age>‘30.’ The database management device 110 receives the query 125 and issues a command 130 to the storage system 115 to perform the query. The management node 114 receives the command 130 and sends an execution command 135 to the storage devices 120-121. Storage devices 120 and 121 each perform the SQL statements regarding their respective tables—storage device 120 performs the WHERE filtering statement for table1, and storage device 121 performs the WHERE filtering statement for table2. The SQL statement requiring a database table join function—WHERE table1.userID=table2.userID—is executed by the management node 114, as is described in more detail below.

Storage devices 120 and 121 may determine database query 125 results locally, that is, database intelligence may be present on the storage to execute the database query 125 and to return results of the query. The returned results 145 are sent to the management node 114. The management node performs any additional SQL processing required to fulfill criteria of the query 125 with final SQL processing 150. Query criteria may include database search criteria (e.g. filter table entries), a database statement, and/or other functions common in database interactions. The results of the query are sent to the database management device 110, and then the final result is passed 155 to the client device 105, where the final result is received 160. The first results returned at step 145 may comprise only those table entries that satisfy one or more criteria of query 125, and need not include other table entries (e.g., need not include table entries not satisfying query criteria). Likewise, the final results from step 140 are only those table results satisfying all criteria of query 125, and need not include any other table entries. Advantageously, this may lead to a substantial reduction in the amount of data that is transferred over I/O in the system, e.g., reduction in data transferred over I/O 113, and further reduction in data transferred over I/O 112 and subsequently I/O 111.

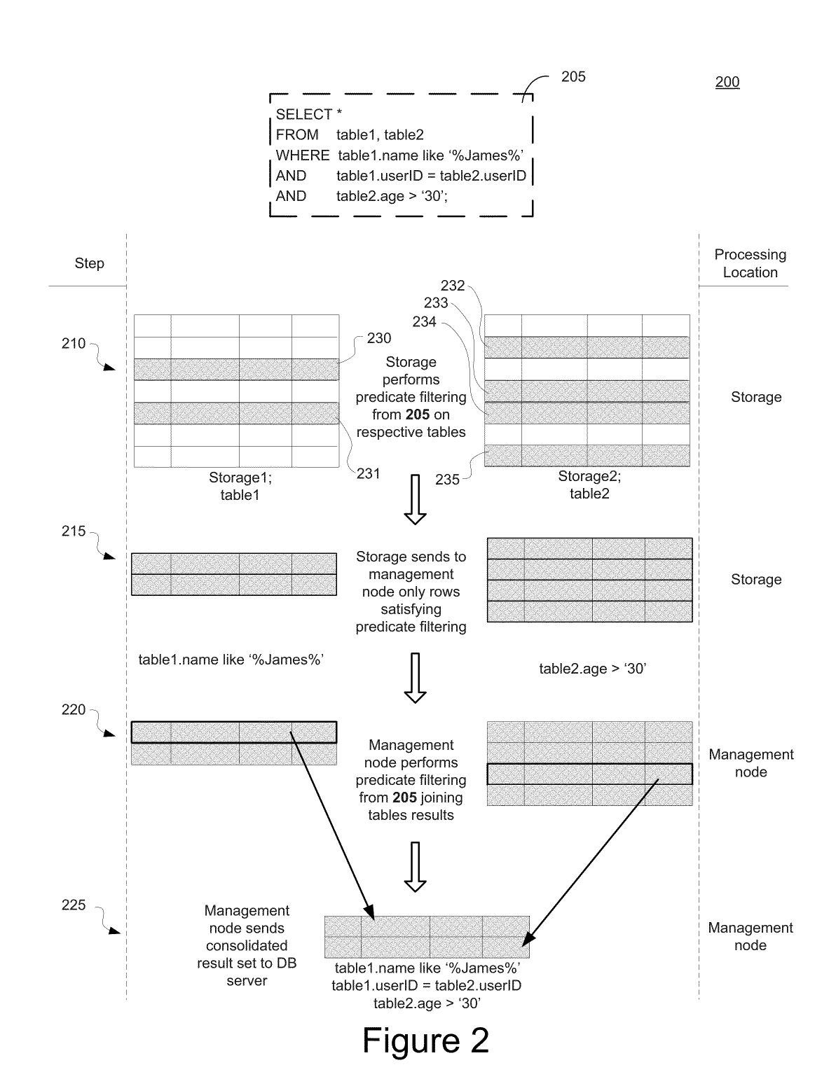

FIG. 2 illustrates an exemplary storage system database query process 200 depicting process steps and the storage system location where a query process is being performed, in accordance with an embodiment of the present disclosure. While the database query process 200 illustrates a join of the equi-join type, other join types are possible—for example, cross joins, inner joins, outer joins, and self-joins. Process 200 illustrates a database query 205 received by the database storage system (such as storage system 115). The database query 205 is a SELECT all statement FROM a table1 and a table2, WHERE table1.name LIKE ‘% James %’ AND table1.userID=table2.userID AND table2.age>‘30’. The storage system receives the query 205 and performs aspects of the query at the individual storage devices containing the tables, and also at the management node of the storage system. At step 210 of the database query process 200, those storage devices containing the referenced tables of the query 205 perform SQL processing according to criteria of the query 205. Table1 is contained by storage device Storage1, and table2 by storage device Storage2. At step 210, Storage1 performs SQL scanning for table1 entries having values that satisfy SQL statement WHERE table1.name LIKE ‘% James %’, and determines table1 rows 230 and 231 satisfy the filter criteria. Also at step 210, Storage2 performs SQL scanning for table2 entries having values that satisfy SQL statement WHERE table2.age>‘30’, and determines table2 rows 232, 233, 234 and 235 contain values satisfying the query criteria.

At step 215 the storage devices Storage1 and Storage2, having determined table values satisfying query 205 criteria in table1 and table2, respectively, may return only those table entries to a management node comprised by the storage system (e.g., management node 114). These returned table entries from the storage devices to the management node may be referred to herein as “first results.”

At step 220, the management node performs SQL processing according to additional criteria of the query 205, namely SELECT WHERE table1.userID=table2.userID. This SQL statement, with reference to two tables stored on two different storage devices, requires a table join in order to find the queried data. Storage1 and Storage2, while able to perform some database query processes locally using on-board computing, cannot perform table joins due to the lack of communication and database knowledge between tables stored on different storage devices. The functionality of performing query processing on two or more tables stored on more than one storage device is provided by the management node, which has database query processing capability and is in communication with each storage device of the storage system (e.g., Storage1 and Storage2). In one embodiment, Storage1 and Storage2 send all table1.userID and table2.userID entries, respectively, to the management node, and the management node performs a database table join and filters according to the query criteria WHERE table1.userID=table2.userID. In one embodiment, Storage1 and Storage2 each sends the whole table, that is, all of their respective table entries, to the management node for further database query processing.

In one embodiment, Storage1 and Storage2 each perform the portion of the SQL query with respect to their contained tables. For example, for a different query statement, WHERE table1.userID=7 AND table2.userID=18, Storage1 performs WHERE table1.userID=7 and returns table entries satisfying that criteria to the management node, while Storage2 performs WHERE table2.userID=18 and returns table entries to the management node. The management node then determines the final results satisfying all query criteria using these storage results (e.g. first results), which may not include the entirety of table1 and table2.

At step 225, the management node determines table values from table1 and table2 satisfying all query 205 criteria, and sends these final results to the requestor (e.g., a client device 105, via database server 110). The final results may be only those table entries from table1 and table2 having values satisfying criteria of query 205. The computing capability comprised by the management node allows the management node to perform SQL (or other database language) queries involving multiple tables across multiple storage devices, and to provide the final result up to the database server. The individual computing at each storage device may perform a WHERE-type query on its own table, and transfer results of the WHERE query to management node (e.g., first results). The management node is able to collect all of the first results from the storage device queries performed across all of the storage devices, and to perform a join-type or other process necessary to perform the full query, and to determine a final result of the query. The final result is then able to be passed up to the database server, the final result representing a smaller data transfer size than would be made if processing in the storage system via management node were not present.

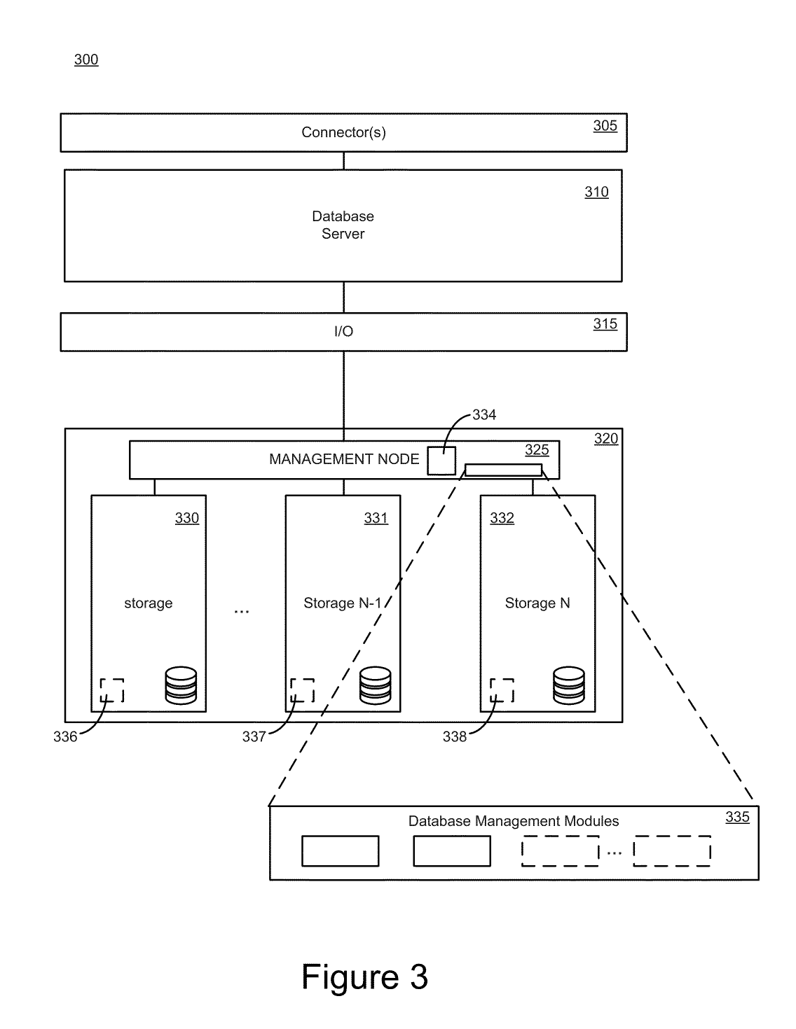

FIG. 3 depicts an exemplary database system 300 according to an embodiment of the present disclosure. The database system 300 may be implemented as a relational database that stores any desired type of data. The database system includes connector(s) 305 for connecting with a client device, such as client device 105 of FIG. 1. The connector(s) 305 may be, for example, a SQL connector, a Representational State Transfer (REST) API connector, a Stream connector, and/or other connectors known in the art. The client connector(s) 305 are in communication with a database management system, such as database server 310. The database server 310 may include database management software configured to cause a database server process to manipulate one or more databases in the database system 300. The database server 310 is in communication with a storage system 320, the storage system 320 including a management node 325 and a number of storage devices 330-332. The management node 325 includes a processor 334 and database management software modules 335. The management node may include database management software configured to cause a database process to manipulate one or more database tables. The storage devices 330-332 store one or more database tables, and each may include a processor (e.g. processors 336-338 comprised by storage devices 330-332, respectively). Components of the database system 300 (database server 310, storage system 320, management node 325, storage devices 333-332, client connector(s) 305) are connected via I/O connectors, illustrated as I/O component 315. I/O connectors comprised by 315 may be, for example, Ethernet, InfiniBand, and/or other I/O architectures and protocols known to one skilled in the art.

In some embodiments according to the present disclosure, the database server 310 and the storage system 320 are contained in separate hardware units (e.g., storage may be a network storage, connected to database by e.g. LAN). In alternative embodiments, the database server 310 and the storage system 320 may be together in one hardware unit, e.g. in a so-called “database appliance.” In either of the above embodiments, the database server 310 and the storage system 320 are separate units and I/O 315 is necessary to perform data transfers between the database server 310 and the storage system 320.

The management node 325 is implemented within the storage system 320. The management node 325 is in communication with each storage device of the storage system 320, e.g. storage devices 330-332. A number of implementation topologies are possible, so long as the management node is in communication with each storage device of the storage system 320, and with the database server 310. For example, the management node 325 may be included in a hardware unit that also houses the storage devices 330-332. Alternatively, the management node 325 may be housed in a hardware unit distinct from the hardware unit comprising the storage devices 330-332, with the management node 325 in communication with the storage devices 330-332. Alternatively, the management node 325 may be housed in one of the hardware units housing one of the storage devices (e.g. storage device 330), and communicatively connected with storage device 330 and to all of the other storage devices (storage devices 331 and 332), and to the database server 310.

I/O 315 may comprise different I/O connectors and protocols at different layers of database system 300. In one embodiment, the I/O 315 for connecting the management node 325 with each storage device 330-332 is of a high-throughput type, such as an InfiniBand connector. In one embodiment I/O 315 connecting the management node 325 with the database server 310 may be of a lower quality, less expensive type (e.g., Ethernet), due to the reduced data transfer requirements between the database server 310 and database storage 320 achieved by techniques and embodiments of the present disclosure. A higher quality (higher throughput) connector between the management node 325 and the storage devices 330-332 improves the speed with which database query results may be returned, since the greatest data transfer may occur with the returning of first results for a database query (e.g., data transfer at step 215 of FIG. 2 contains more data than data transfer at step 225, final results). The subsequent data transfer of final results from the management node 325 to the database server 310 will typically be less than that of the data transfer between the storage devices 330-332 and the management node 325, since the management node 325 performs additional database query processing and may further reduce the data returned.

The database management modules 335 comprised by management node 325 may be configured to cause processor 334 to manipulate one or more databases of database system 300 communicatively coupled to processor 334. The database management modules may comprise parser, transformation, query optimizer, and aggregator modules, each of which may act in a specified manner to perform database processing and manipulation. For example, during a database query (e.g. query 125) a query optimizer module identifies specified database elements according to the database query, and an aggregator module retains the ordering information of data records for the database (e.g., in a column-based and/or a row-based database layout). A transformation module may convert database data into a human-readable format, while a parser module may parse out the data for a client (e.g., present final results of database query). In an embodiment, the database modules 335 comprise functions from at least a query optimizer and an aggregator module, enabling the processor 334 to perform database query processing (e.g. SQL commands) according to embodiments of the present disclosure. Database management modules 335 may comprise further functions from more modules, depending on the processing power of processor 334.

In an embodiment, the database server 310 issues a command to process a database query, and all querying functionality is accomplished at the management node 325 and the storage devices 330-332, with the database server 310 receiving a final result that does not require any further computation. According to an embodiment of the present disclosure, the storage devices 330-332 do not include computing ability (e.g. processors 336-338), and the storage tables 330-332 send the entirety of referenced tables in a database query to the management node 325, where the database query is processed and final results determined. The embodiments described above allow the database server 310 functions to be minimized to command issuance and results output only, with no data processing required regarding filtering of datasets.

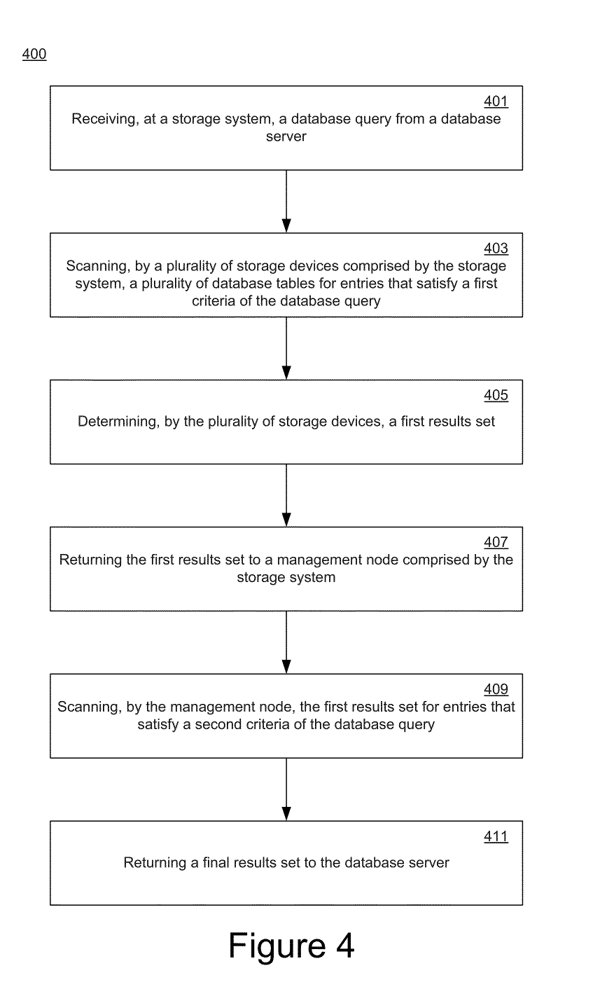

FIG. 4 is a flowchart illustrating an exemplary process 400 for processing a database query by a storage system, according to an embodiment of the present disclosure. Steps 401-411 describe exemplary steps comprising the process depicted in flowchart 400 in accordance with the various embodiments herein described. In one embodiment, the flowchart 400 is implemented as computer-executable instructions stored in a computer-readable medium and performed by a computing device executing a process for processing a database query.

At step 401 a storage system receives a database query from a database server. The database query may reference one or more database tables, stored by one or more storage devices included in the storage system, e.g. the storage system 115. The database query includes one or more criteria defining the process or processes to be performed on the one or more database tables, e.g. query 205 of FIG. 2.

At step 403 storage devices storing the one or more tables referenced by the database query at step 401 scan the one or more tables for entries that satisfy a first criteria of the database query (e.g., step 210 of FIG. 2). The first criteria may include, for example, a filter clause (e.g. a SQL WHERE clause) to find table entries having a value specified by the clause. Other forms of database manipulation are possible and are consistent with the spirit and scope of the present disclosure. The storage devices may include processing units, and may perform SQL processing according to criteria of the query received at step 401.

At step 405 the one or more storage devices determine a first results set (e.g. step 215 of FIG. 2). The storage devices determine the first results set according to table values satisfying the query criteria from step 401. At step 407 the first results set is returned by the one or more storage devices to a management node of the storage system (e.g. management node 325 of FIG. 3). The management node comprises a processor, and is communicatively coupled to each storage device in the storage system, and to the database server. The management node is adapted to perform database query functions on database tables in communication with the management node, for example, the management node may perform SQL processing on database tables according to criteria of the database query received at step 401.

At step 409 the management node scans the first results set for entries that satisfy a second criteria of the database query (e.g. step 220 of FIG. 2). In an embodiment, the second criteria includes a join function with respect to at least two tables, and the management node performs a join of the referenced tables in the database query in order to perform a database manipulation. In an embodiment, the at least two tables are stored in at least two different storage devices of the storage system. In an embodiment according to the present disclosure, the first results set includes only those table values from tables satisfying database query criteria.

At step 411 the management node returns a final results set to the database server (e.g., step 225 of FIG. 2). In an embodiment according to the present disclosure, the final results set includes only those table values from tables satisfying all database query criteria from step 401.

### Exemplary Computing System

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be database servers, storage devices, desktop computer systems, portable computer systems, handheld devices, networking devices or any other device that incorporates hard-wired and/or program logic to implement the techniques.

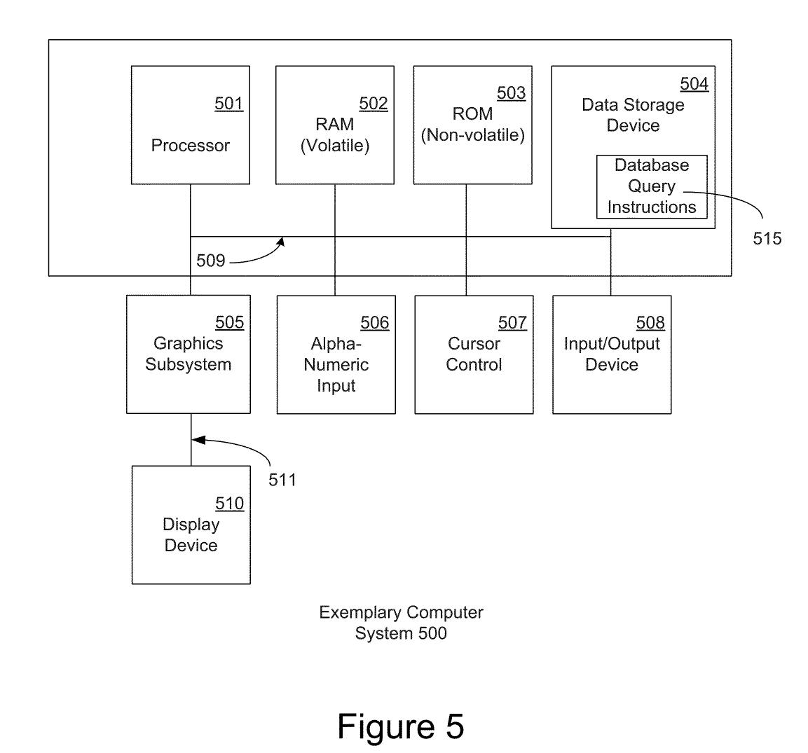

FIG. 5 illustrates an exemplary configuration of an apparatus 500 in accordance with various embodiments of the present disclosure. The exemplary system 500 upon which embodiments of the present invention may be implemented includes a general purpose computing system environment. In its most basic configuration, computing system 500 typically includes at least one processing unit 501 and memory, and an address/data bus 509 (or other interface) for communicating information. Depending on the exact configuration and type of computing system environment, memory may be volatile (such as RAM 502), non-volatile (such as ROM 503, flash memory, etc.) or some combination of the two.

Computer system 500 may also comprise an optional graphics subsystem 505 for presenting information to the computer user, e.g., by displaying information on an attached display device 510, connected by a video cable 511. According to embodiments of the present disclosure, the graphics subsystem 505 may be coupled directly to the display device 510 through the video cable 511. In alternate embodiments, display device 510 may be integrated into the computing system (e.g., a laptop or netbook display panel) and will not require a video cable 511.

Additionally, computing system 500 may also have additional features/functionality. For example, computing system 500 may also include additional storage media (removable and/or non-removable) including, but not limited to, magnetic or optical disks or tape. Such additional storage is illustrated in FIG. 5 by data storage device 504. Computer storage media includes volatile and nonvolatile, removable and non-removable media implemented in any method or technology for storage of information such as computer readable instructions, data structures, program modules or other data. RAM 502, ROM 503, and data storage device 504 are all examples of computer storage media. In an embodiment according to the present disclosure, data storage device 504 may be an attached storage device, such as the storage system 115. Data storage device 504 may include database query instructions 515, which comprise software that is executable by a processor (e.g. 501) to impart the computing system 500 with some or all of the functionality described herein.

Computer system 500 also comprises an optional alphanumeric input device 506, an optional cursor control or directing device 507, and one or more signal communication interfaces (input/output devices, e.g., a network interface card, a transmitter and receiver, also called a “transceiver”) 508. Optional alphanumeric input device 506 can communicate information and command selections to central processor 501. Optional cursor control or directing device 507 is coupled to bus 509 for communicating user input information and command selections to central processor 501. Signal communication interface (input/output device) 508, also coupled to bus 509, can be a serial port. Communication interface 508 may also include wireless communication mechanisms. Using communication interface 508, computer system 500 can be communicatively coupled to other computer systems over a communication network such as the Internet, a software defined network (SDN), or an intranet (e.g., a local area network), or can receive data (e.g., a digital television signal).

In the foregoing detailed description of embodiments of the present invention, numerous specific details have been set forth in order to provide a thorough understanding of the present invention. However, it will be recognized by one of ordinary skill in the art that the present invention is able to be practiced without these specific details. In other instances, well-known methods, procedures, components, and circuits have not been described in detail so as not to unnecessarily obscure aspects of the embodiments of the present invention. Although a method is able to be depicted as a sequence of numbered steps for clarity, the numbering does not necessarily dictate the order of the steps. It should be understood that some of the steps may be skipped, performed in parallel, or performed without the requirement of maintaining a strict order of sequence. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part.

Embodiments according to the present disclosure are thus described. While the present disclosure has been described in particular embodiments, it is intended that the invention shall be limited only to the extent required by the appended claims and the rules and principles of applicable law.

What is claimed is:

1. An apparatus comprising:
a storage device comprising a processor and a plurality of storage units, the storage device comprising a database, the storage device configured for communicative coupling to a database computing device;
wherein the database comprises a plurality of tables stored by the plurality of storage units;
wherein the storage device is configured, in response to a database query, to cause the plurality of storage units to:
scan the plurality of tables for entries that satisfy a first criteria of the database query; and
determine a first results set; and
wherein the storage device is configured to scan the first results set for entries having values that satisfy a second criteria of the database query, and configured to return to the database computing device a final results set including entries having values satisfying all criteria of the database query.

2. The system according to claim 1, wherein the first results set includes entries from at least two tables of the plurality of tables.

3. The system according to claim 2, wherein the final results set includes entries from at least two storage units of the plurality of storage units.

4. The system according to claim 3, wherein the plurality of storage devices comprise a corresponding plurality of storage device processors.

5. The system according to claim 3, wherein the storage device further comprises a management node, the management node comprising the storage device processor, and wherein the plurality of storage units are configured to return the first results set to the management node.

6. The system according to claim 3, wherein the second criteria includes a join statement.

7. The system according to claim 5, wherein the final results set includes only those table entries having values satisfying all criteria of the database query.

8. A method for performing a database query, the method comprising:
receiving a database query;
scanning a plurality of database tables for entries that satisfy a first criteria of the database query;
determining a first results set;
returning the first results set to a management node communicatively coupled to the plurality of database tables;
scanning, by the management node, the first results set for entries that satisfy a second criteria of the database query; and
returning a final results set.

9. The method according to claim 8, wherein the first results set includes entries from at least two tables of the plurality of database tables.

10. The method according to claim 9, wherein the plurality of database tables are comprised by a plurality of storage devices, and wherein the final results set includes entries from at least two storage devices of the plurality of storage units.

11. The method according to claim 10, wherein the second criteria includes a join statement.

12. The method according to claim 10, wherein the plurality of storage devices determine the first results set.

13. The method according to claim 12, wherein the final results set includes only those table entries having values satisfying all criteria of the database query.

14. A machine-readable storage medium comprising machine-readable instructions that, when executed, cause a central processing unit (CPU) to:
perform a database query by:
receiving, at a storage system, the database query from a database server;
scanning, by a plurality of storage devices comprised by the storage system, a plurality of database tables for entries that satisfy a first criteria of the database query;
determining, by the plurality of storage devices, a first results set;
returning the first results set to a management node comprised by the storage system;
scanning, by the management node, the first results set for entries that satisfy a second criteria of the database query; and
returning a final results set to the database server.

15. The machine-readable storage medium according to claim 14, wherein the first results set includes entries from at least two tables of the plurality of tables.

16. The machine-readable storage medium according to claim 15, wherein the final results set includes entries from at least two storage units of the plurality of storage units.

17. The machine-readable storage medium according to claim 16, wherein the plurality of storage devices comprise a corresponding plurality of storage device processors.

18. The machine-readable storage medium according to claim 16, wherein the plurality of storage devices are configured to return the first results set to the management node.

19. The machine-readable storage medium according to claim 16, wherein the second criteria includes a join statement.

20. The machine-readable storage medium according to claim 18, wherein the final results set includes only those table entries having values satisfying all criteria of the database query.
